(19) United States
(12) Patent Application Publication
(10) Pub. No.: US 2014/0165680 A1
(43) Pub. Date: Jun. 19, 2014

(54) SYSTEM FOR PROTECTION OF INTERIOR OF A DEADBOLT LOCK AND RELATED DOOR HANDLE

(71) Applicant: Maxo Noel, Fort Lauderdale, FL (US)

(72) Inventor: Maxo Noel, Fort Lauderdale, FL (US)

(21) Appl. No.: 13/718,537

(22) Filed: Dec. 18, 2012

(51) Int. Cl. E05B 17/20

(52) U.S. Cl. CPC E05B 17/2007
USPC 70/431

(57) ABSTRACT

A system for the protection of an interior of a deadbolt lock and its associated door handle from intruders includes a deadbolt plate including an opening proportioned for enclosing and selectably engaging the door handle. The plate including a solid body element proportioned for engagement about an interior latch of the deadbolt lock and an enclosure proportioned to at least partially cover the solid body element and the latch when the solid element is positioned upon both the latch of the deadbolt lock and the plate is positioned on the door handle. An extension of the deadbolt plate is slidably positioned within an interior slot of the enclosure, and is proportioned to preclude movement of the deadbolt plate after it is positioned upon the latch of the deadbolt lock and door handle.

### BACKGROUND OF THE INVENTION

1. Area of Invention

The invention relates to deadbolt locks and, more particularly systems for the protection of the interior of the deadbolt lock and associated door handle relative to the inside thereof.

2. Prior Art

Deadbolt locks are widely employed to provide an additional level of security to a door and door handle which, often, is already provided with its own internal lock. As such, deadbolt locks are typically placed above, but sometimes below, the door handle to provide a positive interlock between the door and the door frame in addition to whatever local lock may be associated with the door handle. However, and notwithstanding the widespread use of deadbolt locks, intruders and potential intruders of various types have devised means and strategies for defeating deadbolt locks, all of which however require that the latch portion of the deadbolt lock be rotated in some fashion so that the deadbolt lock is then released. Thereafter, it is a simple matter to defeat the local lock provided with or internal to the door handle itself.

The present invention provides a system operable from the inside of a room or dwelling provided with a deadbolt lock to render essentially impossible the rotation of the latch of the deadbolt lock. As such, an enhanced degree of security to persons within a room, dwelling, or the like is provided with the system taught by the present invention. To the knowledge of the inventor, there does not exist prior art which is applicable to the system set forth herein.

### SUMMARY OF THE INVENTION

A system for the protection of an interior of a deadbolt lock in a door and its associated door handle from intruders includes a deadbolt plate including an opening proportioned for enclosing and selectably engaging said door handle, said plate also having a solid body element proportioned for close engagement about an interior latch of said deadbolt lock. An enclosure is proportioned to at least partially cover the solid body element and the latch when said solid element is positioned upon both said latch of the deadbolt lock and the door handle. An extension of said deadbolt plate is slidably positioned within an interior channel of said enclosure, which is proportioned to preclude movement of said deadbolt plate after it is positioned upon said latch of said deadbolt lock and about said door handle.

It is an object of the present invention to provide a system for the protection of a deadbolt system from burglary or the like.

It is a further object to increase the security of deadbolt locks in general.

The above and yet other objects and advantages of the present invention will become apparent from the hereinafter set forth Brief Description of the Drawings, Detailed Description of the Invention, and Claims appended herewith.

### DETAILED DESCRIPTION OF THE INVENTION

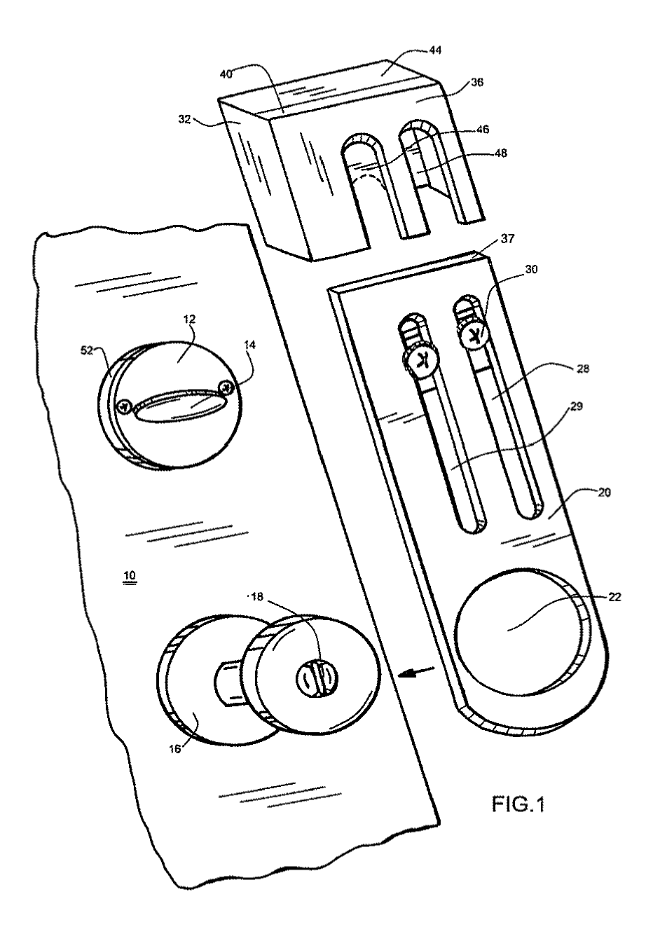

FIG. 1 is an exploded view of the inside of the components associated with the present invention.

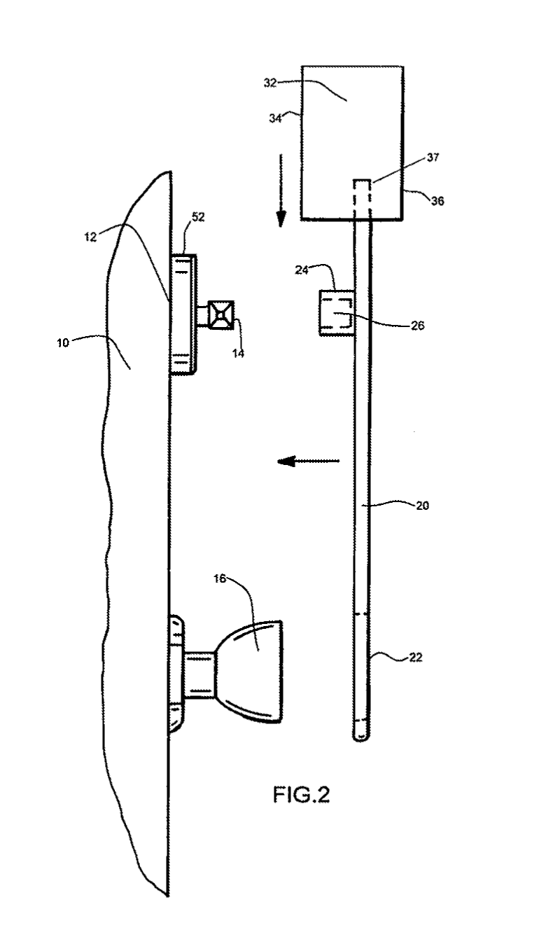

FIG. 2 is a side plan view of the exploded view of FIG. 1.

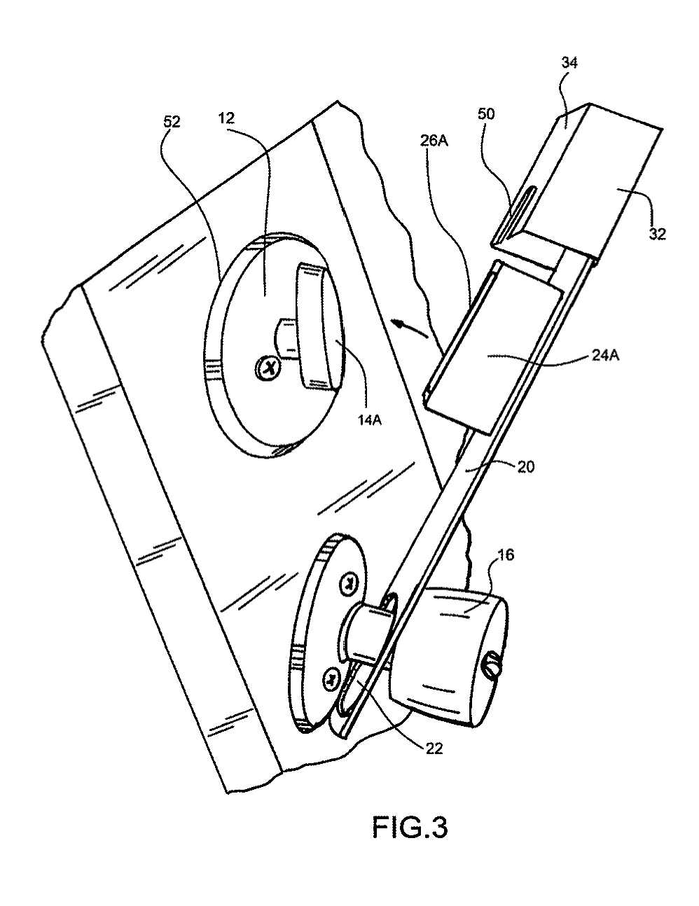

FIG. 3 is a partially exploded view of a vertical latch embodiment of a deadbolt lock protection system showing said system installed over the door handle and positioned relative to the vertical latch of the deadbolt.

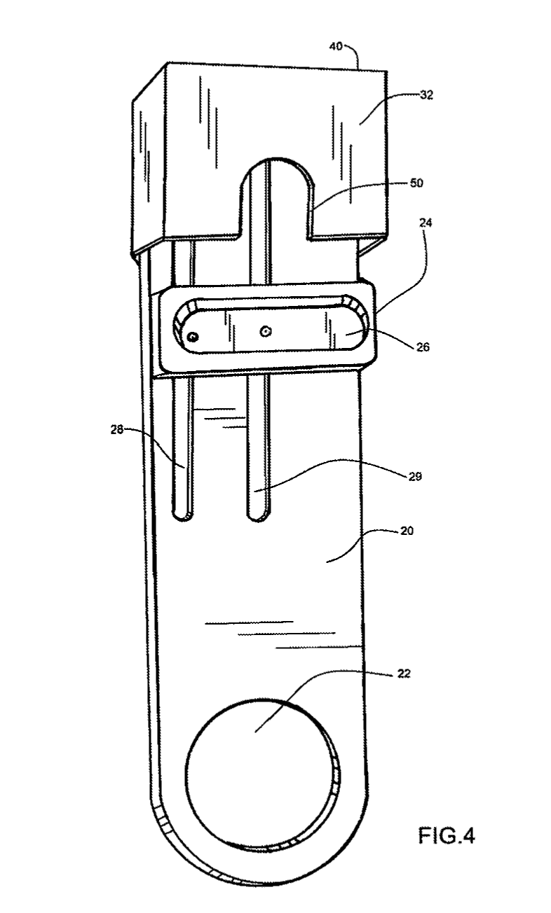

FIG. 4 is a right perspective view of the inventive system shown in FIG. 2.

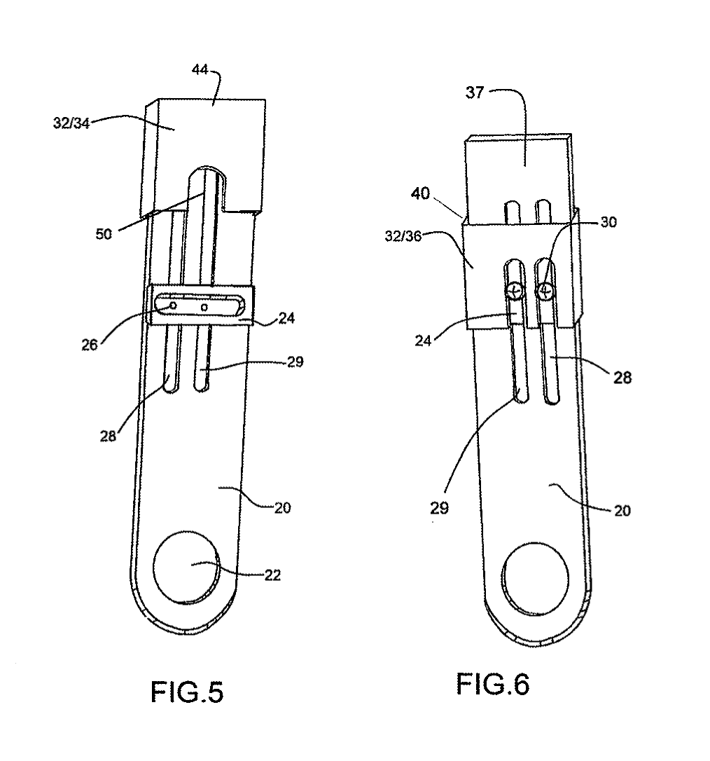

FIG. 5 is a perspective view of a further embodiment of he structure shown in FIG. 4.

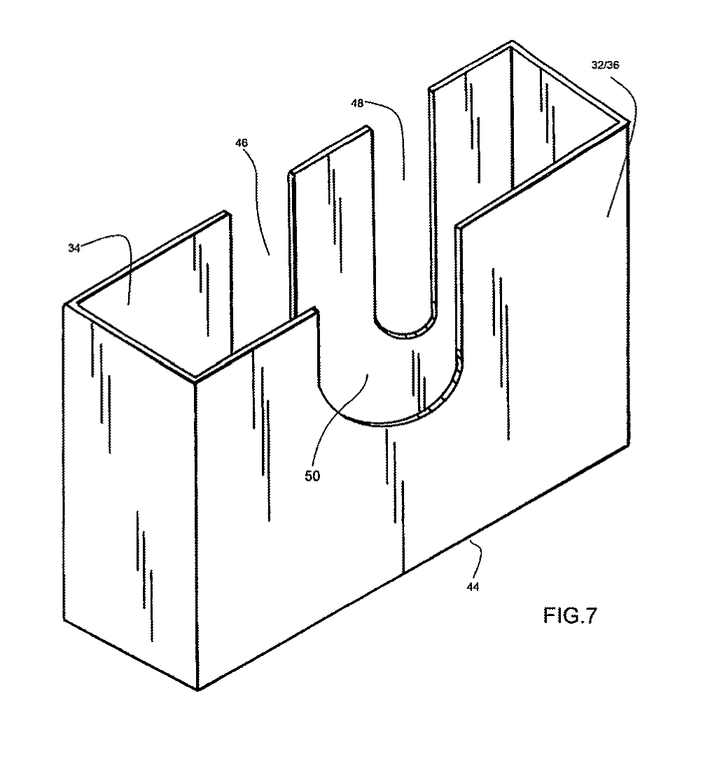

FIG. 6 is a perspective view of the reverse side of the structure shown in FIG. 5.

FIG. 7 is an inverted perspective view of an embodiment of the deadbolt latch protected solid body in accordance with the present invention.

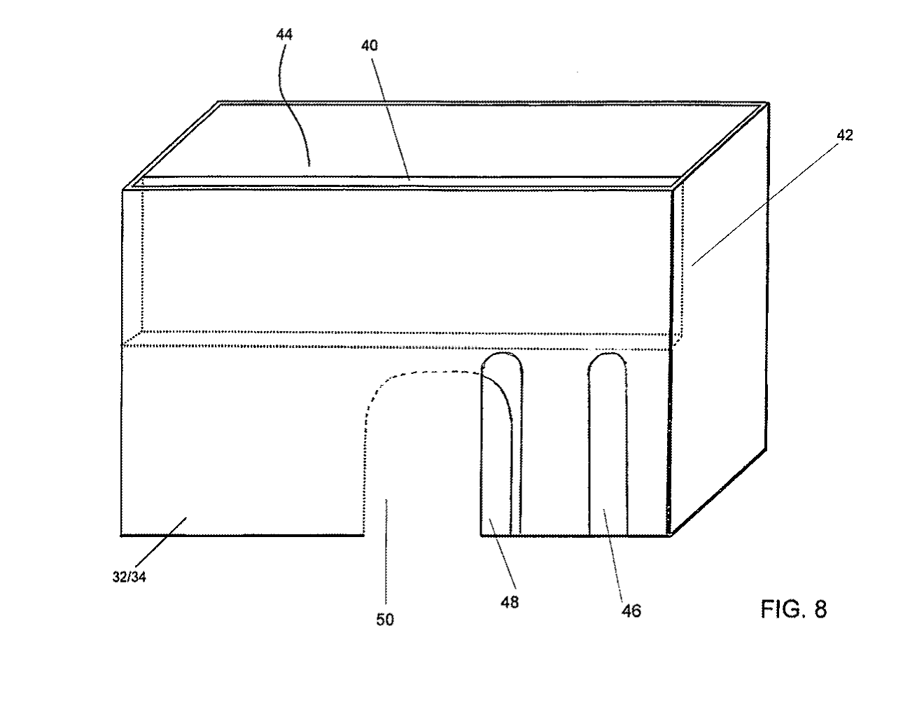

FIG. 8 is a front perspective view of the door enclosure for protecting the solid body element securing the latch of the deadbolt lock.

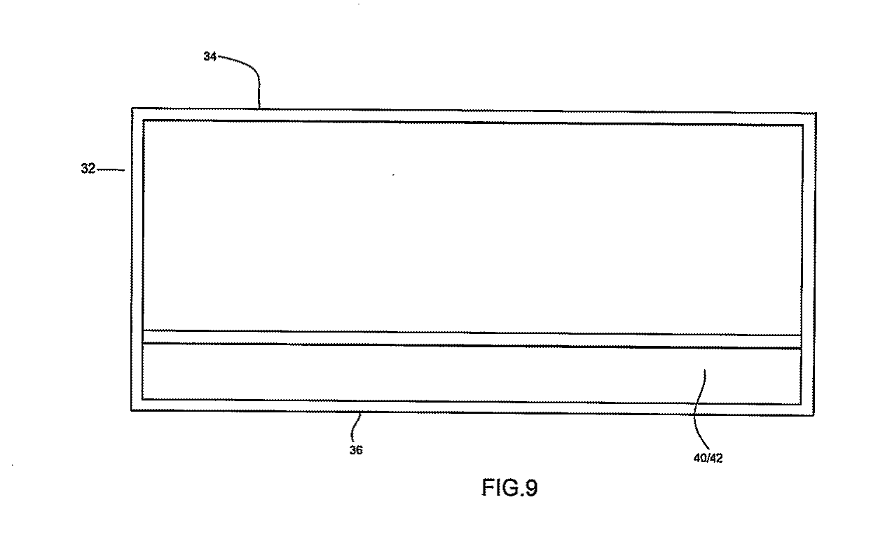

FIG. 9 is a top plan view of the enclosure of FIG. 8.

### DETAILED DESCRIPTION OF THE INVENTION

With reference to FIG. 1, there is shown a generic door 10 which includes a deadbolt lock 12 provided within the door, the lock having a latch 14. Most locksmiths install a deadlock such that latch 14, when turned to a horizontal position, results in the locking of the deadbolt. However some deadlocks, or lock installers, prefer a deadlock in which a latch 14A is in a vertical position when the deadbolt is locked. (See FIG. 3). The invention, as below described is accordingly to be understood with respect to either orientation of the lock 12 or its latch 14 within door 10. In FIG. 1, shown beneath deadlock 12, is a door handle 16 which includes its own local lock 18. It is to be appreciated that while most consumers prefer to locate their door handle beneath the deadlock, in a given application of the invention door handle 16 may be positioned above deadlock 12. Therein the inventive system, as below described, is simply inverted in its use.

With respect to FIGS. 1-4, my system for the protection of a deadbolt lock and its door handle from intruders may be seen to include a deadbolt plate 20 which includes an opening 22 for enclosing and engaging said door handle 16, this as shown in FIG. 3. The inventive system also includes an enclosure, typically in the form of substantially solid element 24 or 24A having an elongate recess 26 or 26A generally conformal in geometry to that of latch 14 or 14A. As may be noted in a comparison of FIG. 1 to FIG. 3, element 24 may be positioned either horizontally as is shown in FIG. 1 or vertically, where said element is denoted with reference numeral 24A, shown in FIG. 3.

As may be noted in FIGS. 1-4, body 26 is slidably securably upon slots 28 and/or 29 of plate 20 through the use of screws 30 or the like. If body 24 and therefore its recess 26 are vertically positioned, as is shown in FIG. 3, then only slot 28 or 29 is employed, in association with said screws 30, for the securement of body 24 or 24A to plate 20.

Further security of the instant system is assured through the provision of an enclosure 32 (see FIGS. 1-4) which includes a door facing surface 34 and opposite surface 36 which faces away form the door toward the interior of the residence or room in which the system is used. Enclosure 32 serves two functions, the first being a spacing of the plate 20 relative to door 10 and the second a stability function of an upper part 37 of plate 20 relative to door 10. Upper part 37 of plate 20 (see FIG. 6) is portioned to slip through mouth 43 of enclosure 32 and through the entire space above mouth 43 and optionally to plate 41 inside of enclosure 32. (See FIGS. 4, 6 and 8). In other words, when plate end 37 of plate 20 is inserted within solid rectangular space 43 of enclosure 32, it becomes essentially impossible for an intruder to defeat the present deadlock protection system unless the entire door 10 is destroyed, That is, as may be noted in FIGS. 5 and 6, it becomes essentially impossible to dislodge screws 30 which hold body 24 to plate 20. In this embodiment, horizontal plate within enclosure 32 is unnecessary and the place can pass through opening 40. As such, if solid body 24 cannot be dislodged, recess 26 of said element 24, which protects the latch 14 from opening, can never be accessed. In FIG. 8, it is to be understood that region 42 of enclosure 32 provides an internal slot for slidable movement of the top 37 of plate 20 within enclosure 32 up to the point that solid body 24 reaches a top of region 50 (described below).

The preferred geometry of enclosure 32 is one which comprises two elongate areas 46 and 48 and a single broader region 50 (see FIGS. 3-5 and 7) at the rear 36 side of enclosure 32. It is also to be appreciated that the curvature of the top of region 50 of enclosure 32 is typically proportioned to engage the perimeter 52 of lock 12 (see FIGS. 1-4) when enclosure 32 is fully positioned on perimeter 52 of lock 12, while areas 46/48 hold and stabilize screws 30 while holding solid body 24/24A. The result is a system that entirely protects the interior of any deadbolt lock system from a potential intruder.

While there has been shown and described above the preferred embodiment of the instant invention it is to be appreciated that the invention may be embodied otherwise than is herein specifically shown and described and that, within said embodiment, certain changes may be made in the form and arrangement of the parts without departing from the underlying ideas or principles of this invention as set forth in the Claims appended herewith.

1. (canceled)

2. (canceled)

3. The system as recited in claim 12, further including:
vertical slots within a surface of said plate opposite said door opposing surface, for longitudinally positioning and securing said integral female element upon said latch and at a desired orientation and distance relative to said door.

4. The system as recited in claim 3, said enclosure including a channel for longitudinally positioning and securing it at a selectable angle relative to said vertical plate.

5. (canceled)

6. The system as recited in claim 4, in which said rigid female element includes an elongate recess generally conformal in geometry to that of said latch of said deadbolt regardless of orientation of said latch.

7. The system as recited in claim 6, in which:
said plate includes longitudinal slots to which said rigid female element may be secured; and
means for selectably securing said rigid female element at a selectable angle enabling a recess of said female element to firmly engage said deadbolt latch without regard to its orientation when closed.

8. The system as recited in claim 3, in which:
said plate includes longitudinal slots through which said female element may be secured; and
means for selectably securing said rigid female element at a selectable angle enabling a recess of said rigid female element to firmly engage said deadbolt latch without regard to its orientation when closed.

9. The system as recited in claim 4, in which:
said plate includes longitudinal slots to which said rigid female element may be secured; and
means for selectably securing said solid body at a selectable angle enabling a recess of said rigid female element to firmly engage said deadbolt latch without regard to its orientation when closed.

10. (canceled)

11. (canceled)

12. The system as recited in claim 15, further comprising:
said enclosure, when positioned about said plate, proportioned to substantially preclude movement of said vertical plate after said door-opposing surface of said enclosure is positioned about said latch of said deadbolt lock, and an opposite distal end of said lower opening of said elongate female integral plate is engaged about said door handle, defining fixed and stable planes between said plate and said door.

13. (canceled)

14. The system as recited in claim 12, in which said enclosure includes an arch proportioned for engagement of an upper portion of a perimeter of said lock thereby securing the lock to both said arch and said vertical plate.

15. A removable system for the protection of an interior of a deadbolt lock in a door and its associated interior door handle from intruders, the system comprising:
(a) a vertically elongate integral plate disposed substantially parallel to said door, the plate including a lower opening proportioned for slidable enclosure about said interior door handle and circumferentially surrounding an axle thereof, said plate also having an integral rigid female element situated distally from said lower opening at a height of said lock above a floor of said door of a room interior, said female element proportioned for slip-fittable engagement upon, against and about said latch of said deadbolt lock; and
(b) open-ended rigid enclosure proportioned to selectably cover said elongate rigid female element and at least a portion of an interior perimeter of said deadbolt lock, said enclosure press-fittably positionable against said perimeter of said lock and about said female element, said enclosure having a vertical channel proportioned to slidably accommodate passage of an upper end of said integral plate therein, and a surface of said enclosure in opposing relation to said door.
